(19) United States
(12) Patent Application Publication
(10) Pub. No.: US 2023/0185908 A1
(43) Pub. Date: Jun. 15, 2023

(54) PRIVACY-AWARE EVENT DETECTION

(71) Applicant: Ambient AI, Inc., San Jose, CA (US)

(72) Inventors: Vikesh Khanna, San Jose, CA (US); Shikhar Shrestha, San Jose, CA (US)

(21) Appl. No.: 18/076,109

(22) Filed: Dec. 6, 2022

Related U.S. Application Data
(60) Provisional application No. 63/289,268, filed on Dec. 14, 2021.

(51) Int. Cl. G06F 21/55; G06F 21/71

(52) U.S. Cl. CPC G06F 21/554; G06F 21/71

(57) ABSTRACT

Variants of the privacy-aware event detection method can include: determining measurements of a monitored space, determining values for a set of primitives from the measurements, optionally sending the primitive values to a remote event detection system, detecting an event based on the primitive values, optionally analyzing the event, and optionally notifying a user of a security threat.

### CROSS-REFERENCE TO RELATED APPLICATIONS

This application claims the benefit of U.S. Provisional Application No., 63/289,268, filed 14 Dec. 2021, which is incorporated in its entirety by this reference.

### TECHNICAL FIELD

This invention relates generally to the security systems field, and more specifically to a new and useful privacy-aware architecture in the security systems field.

### BRIEF DESCRIPTION OF THE FIGURES

FIG. 1 is a flowchart representation of a variant of the method.

FIG. 2 is a schematic representation of a variant of the system.

FIG. 3 is an illustrative example of extracting primitive values from raw measurements.

FIG. 4 is an illustrative example showing data flow through the system.

FIG. 5 is an illustrative example showing data flow through the system.

FIG. 6 is an illustrative example of security event determination.

FIG. 7 is an illustrative example showing data flow through the system.

FIGS. 8A and 8B depict examples of training a primitive extractor and using the primitive extractor for inference, respectively.

FIG. 9 is an illustrative example of extracting primitive values from raw measurements.

FIG. 10 is an illustrative example of event detection using values for a set of predetermined primitives.

### DETAILED DESCRIPTION

The following description of the embodiments of the technology is not intended to limit the invention to these embodiments, but rather to enable any person skilled in the art to make and use this invention.

### 1. Overview.

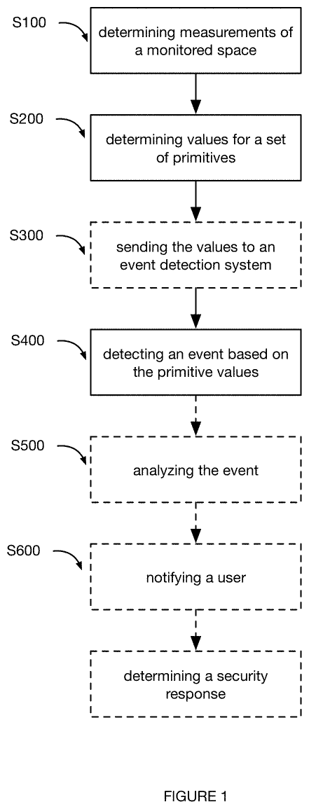

As shown in FIG. 1, variants of the privacy-aware event detection method can include: determining measurements of a monitored space S100, determining values for a set of primitives from the measurements S200, and detecting an event based on the primitive values S400. The privacy-aware event detection method functions to detect security events while preserving the monitored entities' privacy.

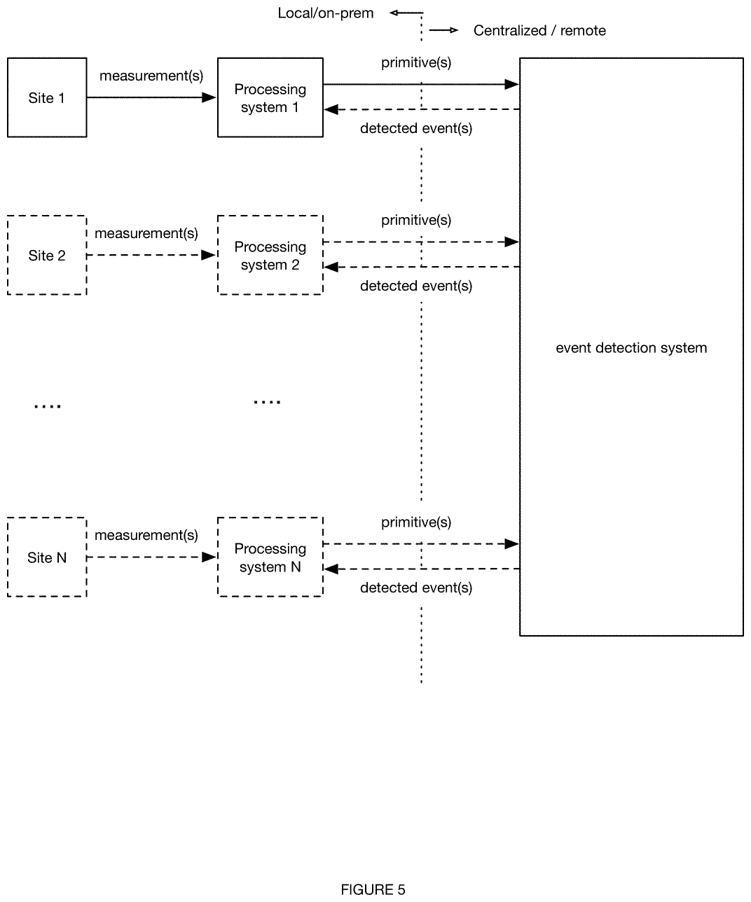

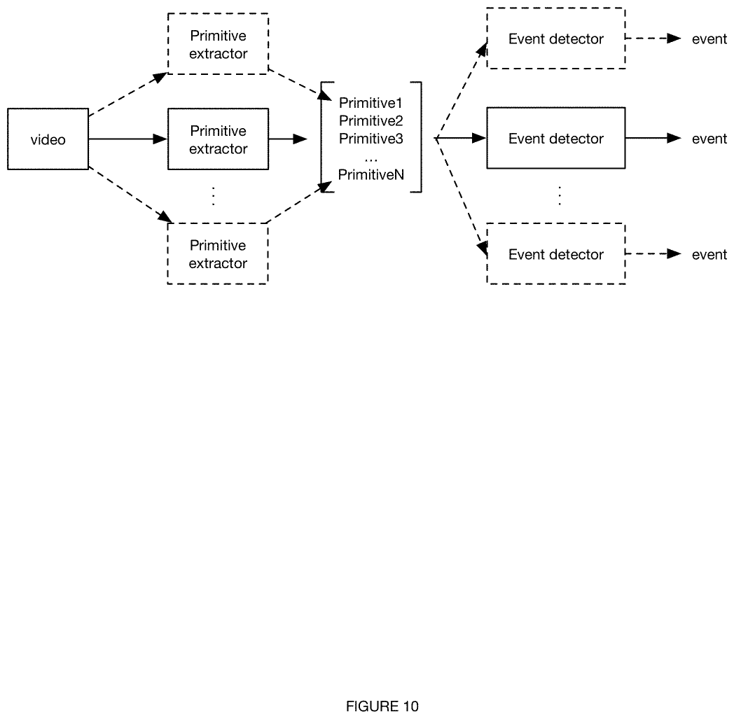

In an illustrative example, the method can include: sampling video of a monitored space S100; extracting values for each of a set of primitives from the video S200 (e.g., wherein the primitives are determined based on features extracted from the video); optionally sending the primitive values to an event detection system S300; and detecting a security event within the monitored space using event detection system based on the primitive values S400. In variants, the primitive values can be extracted on-premises (e.g., on hardware collocated with the monitored space), and the event detection system can be either on-premises or remote from the monitored space. In variants, a remote event detection system can be centralized and service multiple sites (e.g., shown in FIG. 5); this can enable large, complex, up-to-date event detection models to be used for event detection. In variants, the primitives (for which values are extracted) can exclude personally identifiable information (e.g., biometrics, nametags, etc.) and/or bias information (e.g., demographics such as race, gender, age, etc.; visible disability; weight; etc.). In variants, the primitives can be semantic (e.g., have semantic meaning) and/or predetermined, wherein the event detection system can determine the event based on the semantic and/or predetermined primitives (e.g., a vector of primitives, wherein each vector index represents a different primitive; example shown in FIG. 10). In a specific example, this can enable video to be excluded from downstream analyses, wherein only the (fully anonymized) primitives and other anonymized auxiliary data are used for security event detection. The method can optionally determine whether the detected event is a true security event for the monitored space (e.g., S500, whether the detected event is an anomalous event for the space, given the space's event history, etc.), and further notifying a user of a security event S600. However, the method can be otherwise performed.

### 2. Technical Advantages

The technology can confer several benefits over conventional methods and systems.

First, the technology can keep the monitored entities' information private by abstracting away each entity's personally identifiable information (PII), and by detecting the security event based on the abstraction. For example, instead of passing an image of an intruder (the monitored entity)—which includes PII (e.g., the intruder's facial features)—to an event detection model, this technology can abstract the intruder to a primitive, such as an instance of an entity class (“person”), and use the primitive (e.g., entity class instance) for event detection. While, in variants, this means that the event detection system does not use raw measurements (e.g., videos) for event detection, the inventors have discovered that the event detection performance (e.g., accuracy) can be maintained using the primitives.

Second, because the data is anonymized, this allows events to be detected using a centralized event detector while preserving the site manager's custody of the raw measurements. In variants, this, in turn, enables the event detector to be larger, more complex, and/or more frequently updated, since the event detector no longer needs to be pushed to on-site detection systems, nor is it limited by the computing power of on-site computing systems.

Third, the technology can reduce or eliminate event detection bias by not training on or extracting primitives associated with sensitive attributes (e.g., race, age, gender, etc.).

Fourth, the technology can improve the latency, data storage, and analysis speed by storing and/or detecting events based on the primitive values only, not raw measurements (e.g., video, point clouds, etc.). In variants, this minimizes the amount of storage needed to store the timeseries of data generated by each data source (e.g., sensor), monitored space, and/or site. In variants, this can also enable faster transmission from the on-prem system to the cloud system (e.g., the event detector) because the file sizes are smaller. In variants, this can also enable faster analysis, since the event detector is working with vectors of values instead of raw data.

Fifth, variants of the technology can confer explainability to the detected event (e.g., explain why the event detector detected—or did not detect—an event) by using human-interpretable primitives (e.g., attributes that have semantic content) instead of uninterpretable features (e.g., devoid of semantic content).

Sixth, by using anonymized data, variants of the technology can obtain statistically significant training data for event detector training. This can be useful because true security events are sparse and can be difficult for a human to definitively characterize. Because sharing raw measurements is oftentimes regulatorily restricted (e.g., via GDPR, etc.), conventional systems are limited to training event detectors using site-specific data. Unfortunately, the sparsity of true positive ground truth data for a given site might not be statistically significant enough to accurately train an event detection model. Abstracting and anonymizing the raw measurements enables true security events (e.g., events that security personnel have responded to; events that have been validated as true security events, etc.) across multiple sites—which typically do not and cannot share data—to be aggregated and used to train an event detector.

However, further advantages can be provided by the system and method disclosed herein.

### 3. System.

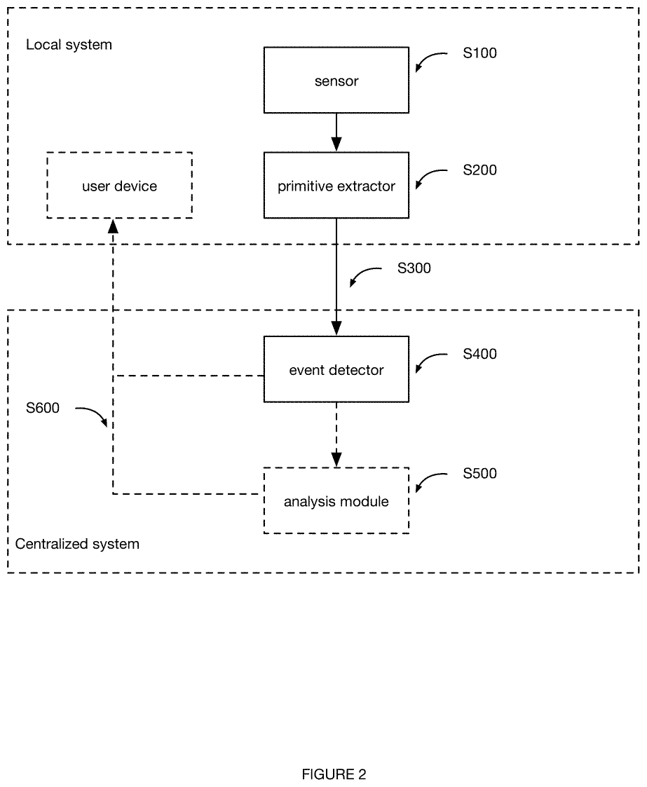

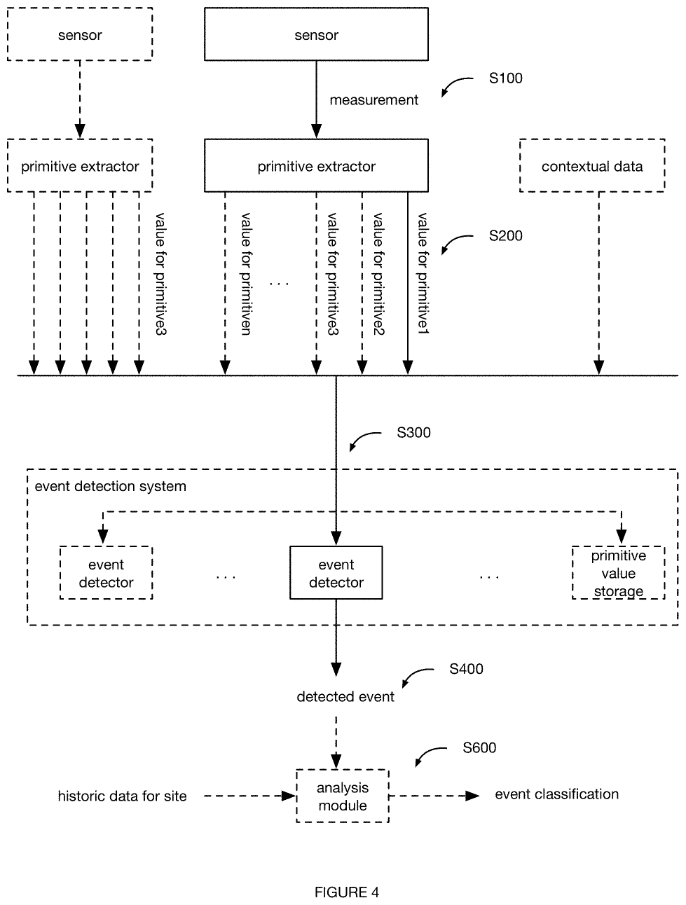

The method can be performed with a system including one or more: sensors, models, and/or other components, example shown in FIG. 2. In variants, the models can include: primitive extractors, event detectors, analysis modules, and/or other models and/or modules. The system can optionally include: a response determination module, an explainability module, and/or other optional components. An example of the system is shown in FIG. 4.

The system can function to monitor one or more physical sites (e.g., premises). The physical sites can be indoor, outdoor, and/or be any other suitable site. The physical sites can be associated with different users (e.g., users, user accounts, site managers), or with the same user. Each physical site can be associated with a site identifier (e.g., unique ID, type of site, etc.), or be unidentified. Each physical site can include one or more monitored spaces. Each monitored space can be associated with a space identifier (e.g., unique ID, type of space, etc.), or be unidentified. Examples of physical sites can include: campuses, buildings, offices, retailers, schools, residences, and/or other sites. Examples of monitored spaces can include: an entryway, a room, a kitchen, a yard, a window, and/or other sub-region within a physical site.

The system can be used with and/or include one or more processing systems. The processing system(s) can function to execute the functionality of the modules and/or method, and/or other steps.

In variants, the system can be executed using: a set of local systems, a centralized system; and/or any other suitable set of computing systems (e.g., example shown in FIG. 2). However, the system can be executed using a purely local system, a purely remote system, a distributed system, a centralized system, a hybrid thereof, and/or any other suitable computing environment.

The local systems are preferably located on the physical sites, but can be collocated with the physical sites, located within the monitored spaces, located remote from the physical sites, and/or be otherwise located. Each physical site can include one or more local systems. The local systems can receive the raw measurements, determine the primitive values, and send the primitive values to the centralized system for event detection, and can optionally receive the detected events from the centralized system, coordinate security responses, and/or perform other functionalities. The local system can store or delete the raw measurements after the primitive values have been extracted. The information transmitted to the centralized system preferably does not include any measurements, but can alternatively include measurements without sensitive data (e.g., that inherently lack PII, that have been verified as omitting PII, that have PII removed) and/or include sensitive data-containing measurements. The local systems can be deployed as self-contained devices that can be installed on-premises, be deployed as a software package that can be installed on an existing computing system, and/or be otherwise deployed.

The centralized system is preferably remote from the local systems, but can alternatively be collocated with one or more of the local systems. The centralized system can be executed on a cloud computing platform, server system, remote computing system, and/or any other suitable computing environment. The system preferably includes a single centralized system, but can alternatively include multiple centralized systems (e.g., for each geographic region, for each site, for each space, etc.). The centralized system detects events for multiple monitored sites and/or spaces (e.g., based on the primitive values from the respective sites and/or spaces), but can additionally or alternatively detect events for a single monitored site and/or space. The centralized system preferably does not receive measurements from the local systems, but can additionally or alternatively receive sensitive data-omitting measurements, sensitive-data-containing measurements, and/or any other suitable information from the local systems. The centralized system can optionally store, for each monitored site and/or space: primitive value histories, detected event histories, security threat histories, contexts (e.g., space-primitive value stream mappings, etc.), and/or any other suitable information.

The system can be used with a set of sensors. The sensors can function to sample measurements of a monitored space. The sensors are preferably statically mounted (e.g., with a known pose) to the monitored space, but can alternatively be actuatable (e.g., attached at a rotary joint), not mounted, mounted to a moving object within a monitored space (e.g., a vehicle, a surveillance robot, etc.), or otherwise associated with the monitored space. Each sensor can be associated with one or more monitored spaces. Each monitored space can be associated with one or more sensors. Examples of sensors can include: cameras, microphones, door sensors, state sensors, access controls (e.g., keypad, keycard sensor, etc.), temperature sensors, metal detectors, light sensors, pressure sensors, radar, time of flight sensors, occupancy sensors, inertial sensors, metal detectors, and/or other sensors. Example of measurements that can be sampled include: images, video, audio, depth, point clouds, door state, window state, light levels, occupancy, access permissions (e.g., whether an entity was granted access), weight, acceleration, and/or any other suitable measurement.

The sensor measurements and/or monitored spaces can be associated with context. The context can be used to: determine primitive values, detect events, detect true security events, and/or otherwise used. In variants, all or a subset of the context can be passed to the event detector (e.g., a centralized event detection system) with the associated primitive values, or be obfuscated from the event detector. The context can include information for a monitored space, a location, a sensor, one or more sensor measurements (e.g., sampling context), primitive values, and/or any other suitable context. Examples of sampling context can include: measurement time, measurement frequency, measurement modalities, other measurements contemporaneously sampled with the measurement, the site and/or space that the measurement depicts, and/or other sampling context. Examples of site and/or space context include: site class, site geometry (e.g., size, dimensions, etc.), space class, space geometry, number of doors, windows, and/or other openings, event detection frequency, commonly detected primitive values (e.g., unique entities, interactions, etc.), and/or other context. Examples of primitive value context can include: the sampling context for the measurements used to determine the primitive value, the values of other primitives derived from the same measurement set, and/or any other suitable context.

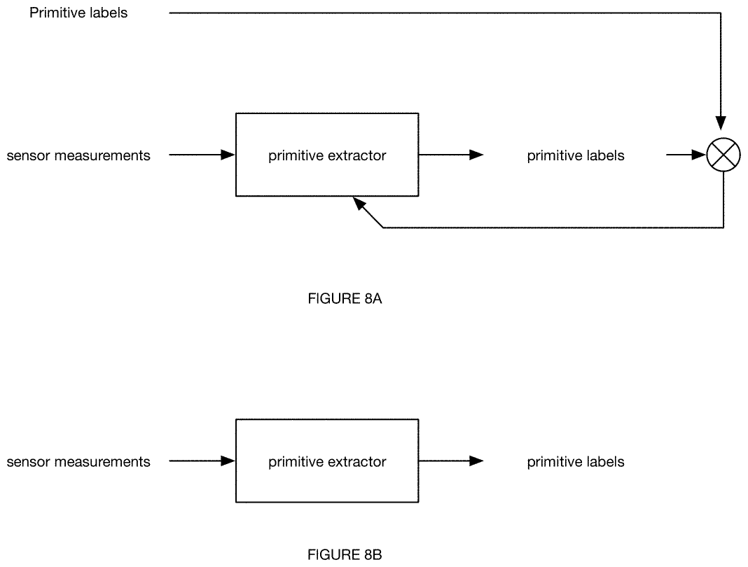

The models can function to extract information from a set of data. The system can be used with and/or include one or more models. A model can be: an NLP model, a neural network (ex: DNN, CNN, autoencoder, etc.), a classifier (e.g., a binary classifier, a multiclass classifier, etc.), a segmentation model (e.g., instance-based segmentation model, semantic segmentation model, etc.), an object detector (e.g., convolutional neural network (CNN), deep neural network (DNN), classical approaches such as Viola-Jones, SIFT, HOG, etc.; etc.), a comparison model (e.g., vector comparison, image comparison, etc.), key point extraction, any computer vision and/or machine learning method (e.g., CV/ML extraction methods, etc.), automated speech recognition models (ASR), optical character recognition models (OCR), and/or any other suitable model. Each model can be executed locally to and/or remotely from the monitored site. Models used with the system can be trained using: self-supervised learning, semi-supervised learning, supervised learning, unsupervised learning, reinforcement learning, transfer learning, Bayesian optimization, using backpropagation methods, and/or otherwise learned. The model can be learned or trained on: labeled data (e.g., data labeled with the target label, example shown in FIG. 8A, etc.), unlabeled data, positive training sets (e.g., a set of data with true positive labels, negative training sets (e.g., a set of data with true negative labels), and/or any other suitable set of data. The trained model can be used for inference for new data (e.g., example shown in FIG. 8B).

Models can include primitive extractors, event detectors, analysis modules, a response determination module, an explainability module, and/or other modules.

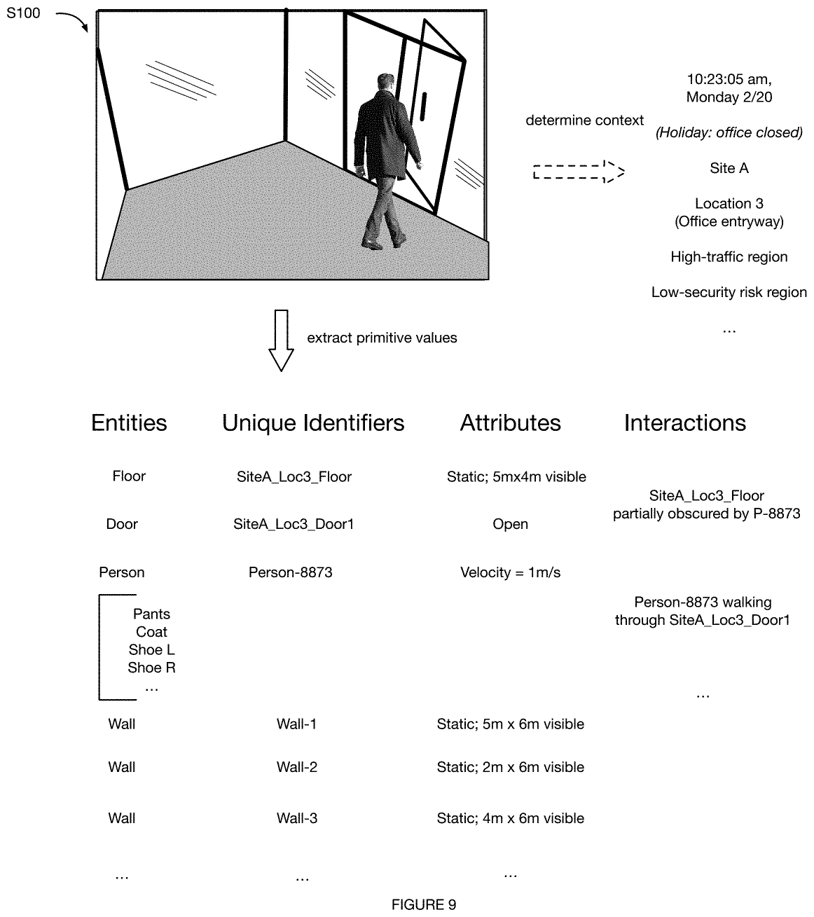

The primitive extractors function to extract metadata (e.g., primitive values) from a set of measurements (e.g., examples of primitives extracted from a measurement shown in FIG. 9). In a first example, the primitive extractors extract the primitive(s) from a single measurement frame (e.g., a single video frame). In a second example, the primitive extractors are configured to extract the primitive(s) from multiple measurement frames (e.g., a series of video frames). In this example, the primitive extractor can optionally include memory (e.g., in the form of weights, a memory of prior states or features, etc.). However, the primitives can be extracted from any other suitable set of measurements. In variants, a primitive extractor can: extract a set of features from one or more measurements (e.g., a single frame, a series of frames), then determine the primitive value based on the set of features (e.g., the feature values). The features can be classical features, such as Haar features, HOG features, SIFT features, features extracted by an upstream layer of a neural network, and/or any other suitable set of features. However, the primitive extractor can be otherwise configured.

A primitive extractor can be: a model (e.g., executing on on-prem hardware, remote hardware, hardware controlled by the site manager, etc.), an ASIC (application-specific integrated circuit), and/or otherwise configured.

The system can include one or more primitive extractors. Each site can include one or more primitive extractors. Each primitive extractor can be generic (e.g., shared by multiple sites) or specific to a site. Each site preferably has the same set of primitive extractors, but can alternatively have different sets of primitive extractors.

A primitive extractor (or set thereof) can ingest one or more sensor modalities (e.g., measurement types). For example, a primitive extractor can be configured to ingest video, images, audio, door sensor states, and/or any other suitable measurement type. A primitive extractor can be specific to a sensor modality, or be generic (e.g., shared) across multiple sensor modalities. A primitive extractor (or set thereof) can be specific to a primitive, or extract values for multiple primitives. A primitive extractor can be: a binary classifier (e.g., determine whether a primitive is present in the measurement), a multiclass classifier (e.g., determine whether each of a set of primitives are present in the measurement), an object detector, set of rules, a set of heuristics (e.g., configured to infer a primitive value), a set of equations, and/or any other suitable model. In a first example, a primitive extractor can be used to extract a single primitive (e.g., one model to detects presence of a human in an image). In a second example, a primitive extractor can be used to extract multiple primitives (e.g., one model detects a person and their attributes, etc.).

A primitive extractor can be trained independently, be tuned (e.g., from a trained base model for a specific primitive), and/or otherwise generated (e.g., trained). For example, each primitive extractor can be trained using measurements labelled with values, bounding boxes, and/or other information for the respective primitive. In a second example, a base primitive extractor can be trained using measurements labeled with values for a given primitive, wherein different instances of the base primitive extractor subsequently can be tuned for other primitives (e.g., using measurements labeled with values for the other primitives). However, the primitive extractor can be otherwise trained.

In examples, the primitive extractors can include one or more of the extractors disclosed in: U.S. application Ser. No. 16/137,782 filed 21 Sep. 2018, U.S. application Ser. No. 16/816,907 filed 12 Mar. 2020, U.S. application Ser. No. 16/696,682 filed 26 Nov. 2019, and/or U.S. application Ser. No. 16/695,538 filed 26 Nov. 2019, each of which is incorporated herein in its entirety by this reference.

A primitive is preferably a semantic descriptor of the scene (e.g., the monitored scene, the monitored site, etc.), but can alternatively be a non-semantic descriptor (e.g., numeric, code-based, etc.). The primitive is preferably human-interpretable, but can alternatively be human-uninterpretable. The primitives extracted from the measurements and/or used in event detection are preferably manually defined (e.g., selected), but can alternatively be automatically selected (e.g., using feature selection techniques), undefined, or otherwise defined. The primitives can include: entities, attributes, interactions, unique identifiers, and/or other descriptors of a given scene. Examples of entities (e.g., nouns) can include: objects (e.g., person, gun, knife, backpack, door, floor, container, weapon, tool, etc.), object components, such as body parts (e.g., arm, hand, eye, etc.), handle, or lid, and/or other entities. Examples of attributes (e.g., adjectives, adverbs, etc.) can include descriptors of the entities, such as: color, height, size, volume, weight, dimensions, position and/or orientation (e.g., relative to a reference frame, such as a monitored site reference frame or the image coordinate system), velocity (e.g., relative to a reference frame), qualitative descriptors (e.g., valuable, highly sensitive, breakable, confidential, etc.), numerosity, cardinality, and/or other descriptors. In variants, the attributes exclude sensitive information, such as PII (e.g., facial features, biometrics, names, voice fingerprints, gait fingerprints, etc.), bias information, physiological data (e.g., height, weight, skin color, etc.), demographics (e.g., gender, race, ethnicity, age, etc.), visible disability indicators, religious indicators, and/or other sensitive information. Examples of interactions (e.g., verbs, prepositions) can include: touching, proximity (e.g., whether one entity is within a predetermined zone or distance of another; estimated distance between entities; etc.), relative location (e.g., “in”, “on”, “in front of”, “behind”, “obscured by”, etc.), verbs, (e.g., hitting, carrying, etc.), timeseries comparisons (e.g., “moving closer to”), single-entity actions (e.g., “falling”, “fallen”, “jumping”, etc.), and/or other interactions between entities, features of the monitored space, and/or other components. The primitives can include: whether or not a given entity, attribute, interaction, or other primitive is present within the measurement (e.g., depicted within the measurement); the entity type, attribute type, interaction type, and/or other primitive type present within the measurement; and/or encode any other suitable information. The primitive values can be binary, discrete, continuous, a text label, and/or be any other suitable value.

Primitives can optionally include unique identifiers assigned to detected entity instances. Examples of unique identifiers can include: serial numbers, random numbers, names, codes, indices, and/or other unique identifiers. The unique identifiers can be: randomly determined, incremented, determined from the feature values extracted by the primitive extractor while determining the primitive value (e.g., a hash of the feature values), and/or otherwise determined. The same entity instance is preferably assigned the same unique identifier across different measurements from the same sensor; alternatively, different identifiers can be assigned to a given entity instance detected in different measurements from the same sensor. The same entity instance is preferably assigned the same unique identifier across measurements from different measurement streams (e.g., sampled by different sensors) within the same monitored site (e.g., same room, same building, etc.), but can alternatively be assigned different identifiers. The same entity instance (e.g., person) is preferably assigned different unique identifiers across measurements from different sites, but can alternatively be assigned the same identifier. Unique identifiers can include semantic information (e.g., “person 24680”, “site1275:door_5”, etc.), or alternatively exclude semantic information. In variants, primitives can optionally include unidentified and/or uncertain entities, attributes, interactions, and/or other values. A primitive can be fully unidentified (e.g., “unidentified object”), partially unidentified (e.g., “unidentified flying object”), and/or otherwise described. Primitive values (e.g., primitive labels) can be extracted by a set of primitive extractors from a set of measurements, be specified by a user, be retrieved from a database, and/or otherwise determined. The primitive value is preferably semantic, but can alternatively be nonsemantic. For example, the primitive value can indicate whether an entity is present within the scene, the type of entity that is present, the type of interactions the entity is having with the scene (e.g., the distance between entities), and/or indicate any other suitable semantic information. A primitive value can be extracted from a single measurement, a set of measurements (e.g., contemporaneously sampled by multiple sensors; timeseries of measurements, measurements monitoring overlapping regions, measurements monitoring the same room, etc.), and/or any other suitable measurement. Each physical site and/or monitored space can be associated with one or more values for a given primitive (e.g., different values extracted from measurements from different timestamps, different values extracted from measurements from different sensor streams, etc.).

The same set of primitives are preferably used for all physical sites and/or monitored spaces; however, different primitive sets (e.g., different subsets of the primitive set, overlapping subsets of the primitive set, etc.) can alternatively be used for different physical sites and/or monitored spaces.

However, the primitive extractor can be otherwise configured.

The system can include one or more event detection systems, which include one or more event detectors. The event detector functions to detect an event (e.g., security event) based on a set of metadata values (e.g., values for a set of primitives, context values, etc.). The values can be from a single sampling epoch (e.g., single timestamp, etc.) or multiple sampling epochs (e.g., a timeseries of primitive value sets). The event detector preferably detects an event for a given space or site based on the primitive values associated with the space or site (e.g., wherein the primitive values are determined from measurements monitoring the space or site), but can additionally or alternatively be detected based on primitive values associated with other spaces (e.g., within the same site, contiguous with the space, etc.) or sites. The event detector can additionally or alternatively detect the event based on: the measurement context (e.g., the monitored space and/or site label or class), the event history for the monitored space and/or physical site (e.g., the site's baseline frequency for a given event), raw measurement values (e.g., from sensing modalities that do not depict PII, such as accelerometers, occupancy sensors, door sensors, and/or access control systems, etc.), and/or any other information. The event detector preferably does not predict events based on measurements, but can alternatively predict events based on measurements. The information can be from one monitored space or from multiple monitored spaces (e.g., within the same physical site).

The events detected by the event detector are preferably security events, but can additionally or alternatively be any other suitable event. The event detector can determine: whether an event is occurring (e.g., event or non-event), the event class (e.g., shooter, theft, robbery, bombing, kidnapping, burglary, vandalism, door propped open, etc.), whether a security response was implemented, whether the security response was successful in mitigating the security risk associated with the event, and/or any other suitable event parameter. The event detector and/or another module can additionally or alternatively determine event metadata, such as the event site or space, the event duration, the entity classes involved, the number of entities, a history of primitive values (e.g., the entity trajectory, what the entity was doing before the event occurred, etc.), and/or any other suitable event metadata. The event metadata can be determined from the primitive values used to detect the event, from the context associated with said primitive values, and/or from any other suitable information. However, the event detected by the event detector can be otherwise defined.

The event detector can be a model, a set of models (e.g., a single model, an ensemble of models, a cascade of models, etc.), a system (e.g., a computing system executing a model), and/or otherwise configured. The event detector can include: a DNN, CNN a classifier (e.g., binary classifier, multiclass classifier), probabilistic graph, a set of rules or heuristics, and/or any other suitable model or event detector. Different event detectors can have the same or different architectures. In examples, the event detector can be one or more of the detectors disclosed in: U.S. application Ser. No. 16/137,782 filed 21 Sep. 2018, U.S. application Ser. No. 16/816,907 filed 12 Mar. 2020, U.S. application Ser. No. 16/696,682 filed 26 Nov. 2019, and/or U.S. application Ser. No. 16/695,538 filed 26 Nov. 2019, each of which is incorporated herein in its entirety by this reference.

The event detector preferably detects the event(s) for each site and/or space based on the same set of information (e.g., primitives, context, measurements, etc.), but can additionally or alternatively detect the event(s) based on different information for different sites and/or spaces. For example, the event detector can detect the event(s) based on the same set of primitives (primitive set) from all sites, a subset of the primitive set from each site (e.g., wherein the event detector is trained to determine the event based on the entire primitive set and/or a subset thereof), and/or any other suitable combination of primitives. In an illustrative example, the event detector can accept a vector including values for each of a set of primitives, wherein the vector index is associated with a predetermined primitive from the primitive set.

The system can include a single event detector, multiple event detectors (e.g., for different event types, different sites, different spaces, different site types, space types, etc.), and/or any other suitable number of event detectors. In a first example, the system can include a single event detector configured to detect the occurrence of one or more events (e.g., a multiclass event detector). In a second example, the system can include a different event detector for each event to be detected. The events for every site and/or space monitored by the system are preferably detected by the same event detector (e.g., the same or different instance thereof), but can alternatively be detected by different event detectors (e.g., specific to the site and/or space).

The event detector is preferably centralized (e.g., executed by a single computing environment, cloud environment, remote computing system, etc.) and services multiple sites (e.g., example shown in FIG. 5), but can alternatively be distributed, replicated across sites or spaces, and/or otherwise configured. In an example, a centralized event detector is used for event detection for all sites, using each site's primitive values. In an alternative example, different instances of the same event detector can be used for event detection for different sites (e.g., different categories of sites, different levels of service offered to sites, etc.).The event detector is preferably executed in the cloud (e.g., on a centralized platform, remote computing system, etc.; variant shown in FIG. 2), but can alternatively be executed on-prem (e.g., on-site, colocalized with the physical site, etc.), executed by a distributed computing system, and/or otherwise executed. The event detector can be trained on primitive value sets labeled with event labels, or otherwise trained. The primitive value sets are preferably sourced from multiple physical sites and/or monitored spaces, but can alternatively be sourced from a single physical site and/or monitored space. The event labels can be: manually determined, automatically determined (e.g., based on the site's security personnel response associated with the respective primitive value set, etc.), and/or otherwise determined. The primitives used to train the event detector preferably exclude sensitive information (e.g., PII, bias information, etc.), but can be otherwise constructed.

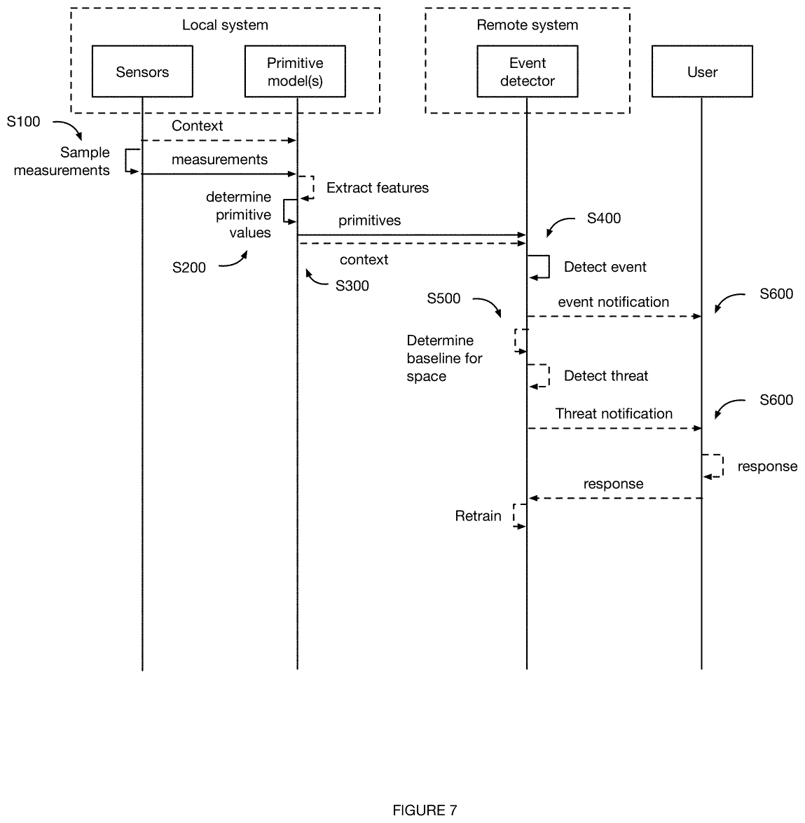

As shown in FIG. 7, the event detector can be trained once, iteratively retrained (e.g., responsive to a user response, security response, the event detection accuracy falling below a threshold value, etc.), periodically, upon gathering a threshold amount of new data (e.g., labeled or unlabeled), when detection error (number or percentage of false positive events) exceeds a threshold, at a manually specified time, and/or at any other suitable time and/or frequency. In a first example, a user can label a detected event as either a security event or non-security event (e.g., by triggering a security response or dismissing the notification, respectively), wherein the event detector can be retrained or tuned based on the primitive value set used to detect the event and the user-provided label.

However, the event detector(s) can be otherwise configured.

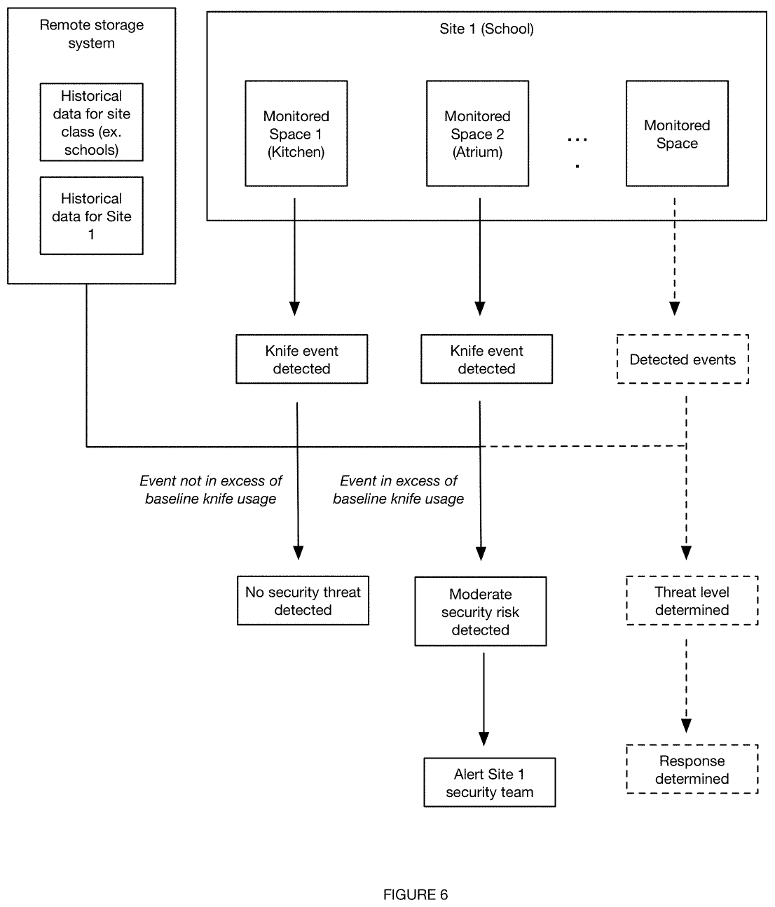

The optional analysis module can function to determine whether a detected event is a true security event for a site or monitored space. This enables a similar event to be classified as a true security event in one context but not in another. For example, a knife pickup event is classified as a true security event when detected in an atrium but not when it is detected in a kitchen (e.g., example shown in FIG. 6). In another example, a running event is classified as a true security event when detected in a store but not when detected in a gymnasium.

The system preferably includes multiple analyses modules (e.g., wherein each analysis module is specific to different space types, different space instances, different physical sites, etc.), but can alternatively include a single analysis module or no analysis module. Examples of analysis modules can include: rulesets, heuristics, baselines (e.g., wherein a true security event is detected when the event deviates from a baseline occurrence frequency or intensity, etc.), anomaly detectors, classifiers, and/or any other suitable model. The analysis module can classify the detected event as a true security event based on: the detected event itself, the measurement context associated with the detected event (e.g., determined based on the context associated with the primitive values used to detect the event), the context for the space (e.g., the space class, the history of event occurrence for the space), and/or based on any other suitable information. In a specific example, the analysis module can leverage the graph discussed in U.S. application Ser. No. 16/695,538 filed 26 Nov. 2019. Each analysis module can be generated (e.g., trained, learned, etc.) based on historic data specific to the respective site or space, but can alternatively be generated based on historic data aggregated across sites or spaces, or otherwise generated.

In a first variant, the occurrence frequency for a given event can be tracked for each monitored space, wherein a true security event can be detected when the occurrence frequency exceeds a baseline frequency (e.g., determined based on a historical occurrence frequency average over all time, a sliding window, and/or another timeframe, etc.). In second variant, a true security event is detected based on a set of rules or heuristics for the monitored space (e.g., based on the space type, manually assigned, etc.). In a third variant, the event detector is a trained neural network that classifies the event as a security event or non-security event based on the detected event, the context, the space history, and/or other information. However, events can be otherwise classified as true security events.

The optional response determination module can function to determine a security response to a detected security event. Example security responses can include: alert a user, deploy personnel, lock doors, open doors, sound alarm, notify law enforcement, request medical assistance, and/or any other suitable response. Additionally or alternatively, the response can be determined by a user. The system can optionally execute and/or trigger a security response (e.g., immediately, upon confirmation, etc.). Alternatively, the system can communicate a suggested response to a user(s) (e.g., at a user device, at a user interface, etc.). The response determination module can incorporate a decision tree, ruleset, heuristic, a lookup table (e.g., mapping security events to responses), a model trained on historical events and responses, and/or any other suitable model.

The optional explainability module can function to provide an explanation to justify the system's determination of a security threat and/or lack thereof. The explainability module can surface the set of most influential primitive values, identify the set of rules or decision tree branch that resulted in the event being detected or event classification as a security threat, and/or otherwise explain the detected event and/or security threat classification. The explainability module can be combined with the response determination module (e.g., to provide a justification to alerted users for a suggested security response), be a separate module, and/or be otherwise related to other models. The explainability module can include: coefficient determination, local interpretable model-agnostic explanations (LIME), Shapley Additive explanations (SHAP), Ancors, DeepLift, Layer-Wise Relevance Propagation, contrastive explanations method (CEM), counterfactual explanation, Protodash, Permutation importance (PIMP), L2X, partial dependence plots (PDPs), individual conditional expectation (ICE) plots, accumulated local effect (ALE) plots, Local Interpretable Visual Explanations (LIVE), break Down, ProfWeight, Super sparse Linear Integer Models (SLIM), generalized additive models with pairwise interactions (GA2Ms), Boolean Rule Column Generation, Generalized Linear Rule Models, Teaching Explanations for Decisions (TED), lift analysis, gradient explanation, deconvolution, class activation maps, and/or any other suitable explainability models and/or methodologies.

However, the system can include any other suitable component.

### 4. Method.

As shown in FIG. 1, variants of the method can include: determining a set of measurements of a monitored space S100; determining values for a set of primitives from the set of measurements S200; and detecting an event based on the primitive values S400. The method is preferably performed using the system discussed above, but can be performed using any other suitable set of systems. Different instances of all or a portion of the method (e.g., variants thereof) can be performed for different monitored spaces. The method or portions thereof can be performed continuously, periodically, randomly, or at any other time and/or frequency. Preferably, S100 and S200 are performed entirely on-premises (e.g., collocated with the physical site) and S400 is performed remotely (e.g., at a remote computing system, at a cloud computing system, etc.). Alternatively, any portion of the method can be entirely or partially performed: locally (e.g., on-premises), remotely, and/or otherwise performed. All of and/or portions of the method can be performed in: real-time/near-real time, asynchronously, serially, in parallel, and/or otherwise performed.

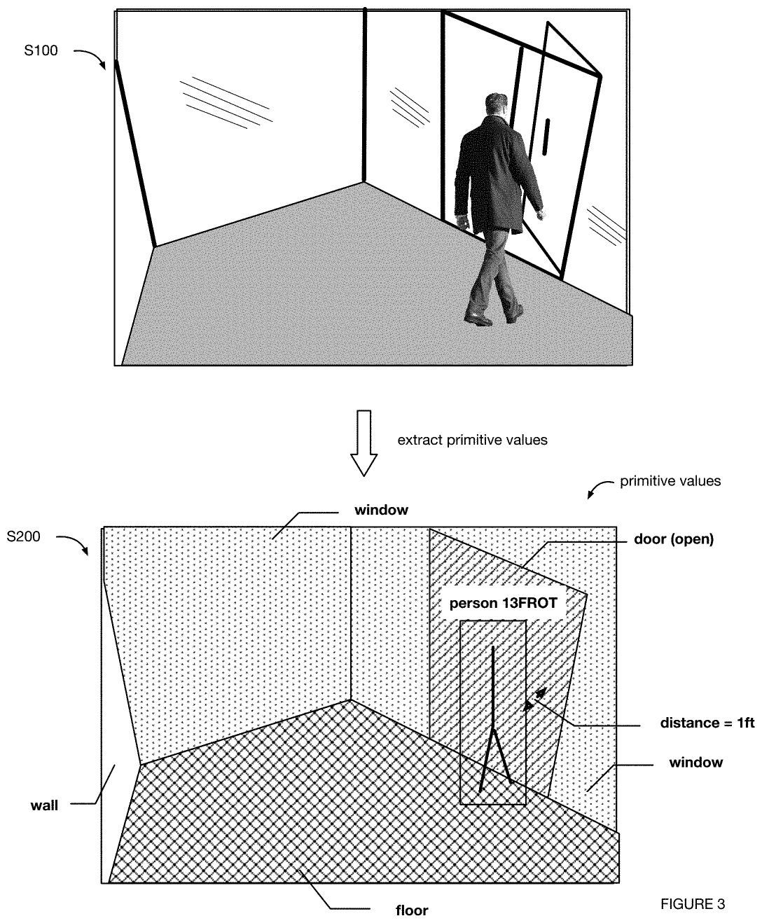

Determining a set of measurements of a monitored space S100 functions to obtain raw data indicative of the monitored space's state (e.g., security state), example shown in FIG. 3. The measurements can include sensitive information (e.g., PII, etc.), or exclude sensitive information. S100 can be performed contemporaneously (e.g., in real time) or asynchronously from measurement sampling. S100 is preferably performed on-site (e.g., on-prem, collocated with the physical site, etc.), but can alternatively be performed remote from the monitored physical site. The measurements are preferably continuously sampled at a predetermined frequency (e.g., frame rate of the camera, sampling rate of the accelerometer, etc.), but can alternatively be sampled responsive to a sampling request, responsive to a scene change, or at any other suitable time. The measurements are preferably sampled by the in-situ sensors, but can alternatively be retrieved (e.g., from a database), and/or otherwise determined. Measurements from one or more sensors can be concurrently sampled, contemporaneously sampled, and/or sampled with any other suitable relationship. Examples of measurements can include: images, video, point clouds, door state, access sensor state (e.g., keypad state, keycard state, etc.), temperature, light, pressure, humidity, magnetic field perturbations, and/or any other suitable measurement. The measurements can be: sampled (e.g., with the sensors), sent and/or received at the local processing system (e.g., from the sensors), and/or otherwise determined.

Determining values for a set of primitives from the set of measurement set S200 can function to extract metadata values for a set of semantic primitives (e.g., human-interpretable features), example shown in FIG. 3. For example, S200 can include: determining (e.g., detecting) entities, determining attributes, determining interactions, determining (e.g., assigning) unique identifiers, and/or otherwise determine metadata. S200 can optionally include not extracting values for features related to sensitive information (e.g., demographic features, such as race, gender, age, etc.). Values for the same set of primitives are preferably extracted for each monitored space and/or site; alternatively, different sets of primitives can be extracted for different monitored space and/or site classes, different monitored space and/or site instances, and/or any other suitable space and/or site. S200 can be performed contemporaneously (e.g., in real time) or asynchronously from S100. S200 is preferably performed on-site (e.g., on-prem, collocated with the physical site, etc.), but can alternatively be performed remotely from the monitored physical site. The values can be determined using a set of primitive extractors (e.g., models trained to extract primitive values from the measurement stream; hardware executing said models, etc.), be retrieved from a database, calculated, retrieved, received, and/or otherwise determined. The values can be determined from: one sensor measurement frame, multiple frames from same sensor data stream, multiple frames from different sensor streams (e.g., wherein the measurements are contemporaneous or sampled within the same measurement epoch &/or timeframe, wherein the measurements are of the same or different monitored spaces or sites, wherein the measurements are associated with a given primitive, etc.), and/or from any other suitable set of measurements. The values can additionally or alternatively be determined based on: the measurement context, the monitored space's context, historical primitive values, and/or any other suitable set of information.

In a first variant, entities and/or associated poses (e.g., position, orientation, etc.) within a monitored space can be determined using an entity primitive extractor (e.g., segmentation model, classifier, object detector, etc.) based on a video frame (e.g., still frame) of the monitored space. However, the entities can be otherwise determined.

In a second variant, inter-entity interactions and/or a timeseries thereof can be determined using an interaction primitive extractor (e.g., classifier, set of heuristics, etc.) based on a set (e.g., timeseries) of video frames, a set of primitive values (e.g., a timeseries of entities and their respective poses), and/or other information. In an example, interactions can be determined based on relative poses between entities and/or components thereof (e.g., in a single sensor measurement frame). Specific examples of such interactions can include: entity A and entity B facing toward/away from each other, a distance between entities, hand arranged distal from torso & proximal knife, etc.

However, the values can be otherwise determined.

The set of primitive extractors used in S200 can include: a different extractor for each measurement modality or measurement stream, a single extractor for multiple measurement modalities or measurement streams, and/or any other suitable number of extractors. The set of primitive extractors can include a different extractor for each primitive, a different extractor for each primitive class, a single extractor, and/or any other suitable number of extractors. Each primitive extractor can ingest the same or different set of measurement types. For example, a first primitive extractor can only ingest video frames, while another primitive extractor can ingest video frames, door states, and access control states.

S200 can optionally include assigning unique identifiers to one or more detected entities, which can enable the entity to be tracked over multiple frames, through different monitored spaces, through different monitored sites, and/or otherwise tracked. This is preferably done locally, but can alternatively be done remotely. A unique identifier can be assigned for a predetermined set of entity classes, all entity classes, and/or any other suitable set of primitive classes. A unique identifier can be assigned to: all detected entities (e.g., within the class), a subset of detected entities (e.g., only entities associated with a detected event or security threat, only entities associated with a predetermined set of interactions, etc.), and/or any other set of primitives. Preferably, the same unique ID is assigned to the same entity instance detected in frames from the same measurement stream (e.g., same video stream) and/or measurements of the same monitored space, but can additionally or alternatively be assigned to the same entity instance detected across different measurement streams and/or across different monitored spaces of the same monitored site (e.g., wherein the primitive extractor can store a feature vector representative of the entity instance to recognize the entity instance in another measurement frame or stream) and/or different monitored sites (e.g., wherein the feature vector can be shared with the centralized system). The unique ID can be persistent for a given entity instance, expire after a predetermined time period, and/or be otherwise persistent or temporary. In a first example, the same ID is assigned to a person detected in different frames within a video stream (e.g., based on a set of features extracted by a feature extractor trained to be agnostic to pose, lighting conditions, obfuscations, and/or other common changes). In a second example, the same ID is assigned to a person detected in different video streams from different rooms. In a third example, the same ID is assigned to a person detected in a video image stream and in an audio stream (e.g., based on a set of heuristics). Assigning the unique identifier to a unique entity instance preferably includes: storing entity information and reidentifying the entity in a second measurement (e.g., subsequent measurement) using the entity information. The entity information that is stored can include: sensor measurements, features extracted from the measurements (e.g., appearance features, audio features, signal features, etc.), and/or any other suitable information. The entity information can be stored in association with the monitored space or measurement stream and/or otherwise stored. The entity information can be stored in a database, in short-term memory, in the model (e.g., in a model layer, as a set of weights or variable values, etc.), and/or otherwise stored.

The method can optionally include determining context, which can function to enable more accurate classification of a detected event as a security event or a non-security event. The context can be determined at setup, periodically determined, and/or determined at any other suitable frequency. The context can be for: a set of primitive values, a set of measurements, a set of sensors, a monitored space or site, a geolocation, and/or be any other context. Contextual data for a site can be stored by the local processing system, the remote processing system (e.g., centralized system), and/or any other suitable processing system. The context can be determined by: receiving user input (e.g., wherein a user can input information about their site, its risks, and upcoming events/threats/changes in personnel, etc.; etc.), inferring the context (e.g., based on pattern matching the primitive values), retrieved from the sensor, and/or otherwise determined.

The method can optionally include sending the primitive values to an event detection system S300, which functions to distance (e.g., isolate) the event detection system from the sensitive information (e.g., contained in the raw measurements), example shown in FIG. 4. This can function to ensure: that the event detection system does not consider sensitive information when detecting a security event, that the identity of the detected entity is not associated with the security event, and/or otherwise isolate the event detection system (or platform executing the event detection system) from knowledge of the detected entity's identity. The event detection system is preferably a separate model from the primitive extractors, but can alternatively be part of the same model. The event detection system is preferably physically remote from the physical site (e.g., on a platform, remote computing system, etc.), but can alternatively be collocated with the physical site (e.g., executed on on-prem servers). The event detection system is preferably centralized (e.g., shared by multiple users, physical sites, monitored spaces, etc.), but can alternatively be decentralized. The primitive values are preferably sent in real-time, as the primitive values are generated, but can alternatively be sent in batches (e.g., at a predetermined frequency) and/or at any other suitable time. The primitive values can be sent by: the primitive extractor, an aggregation system (e.g., on-prem aggregation system), and/or by any other suitable source. The data sent to the event detection system can include: the primitive values, the sensor identifier, the site identifier, the monitored space identifier, a timestamp, context, and/or other information. The data is optionally stored by the event detection system (e.g., persistently, cached, etc.). Values for or a subset of the primitive values can be sent to the event detection system. For example, null values or values for primitives unassociated with the monitored space can be excluded from the transmission. However, any other suitable set of primitive values can be sent to the event detection system.

The method can optionally include deleting raw and/or processed sensor measurements S350, which can function to remove sensitive information (e.g., PII) from the system (e.g., in compliance with regulatory requirements). The sensor measurements are preferably deleted by the local processing system(s), but can additionally or alternatively be deleted by the remote processing system and/or by any other suitable system. The sensor measurements can be deleted by: wiping the measurements from memory, overwriting the measurements, and/or otherwise removed. The sensor measurements can be deleted after primitive extraction from the sensor measurements (and/or at any other suitable time. The sensor measurements can be deleted: immediately, after a predetermined duration, after S300 (e.g., upon successful receipt of primitive data transfer), after a time delay (e.g., stored data periodically deleted, deleted after a pre-specified duration, etc.), conditionally (e.g., if no security event detected), manually (e.g., stored indefinitely and deleted upon receipt of a user request), and/or at any other time. For example, sensor measurements containing PII can be temporarily stored (e.g., for verifying &/or tracking identity of a detected entity). All sensor measurements or a portion of sensor data (e.g., those containing sensitive information, such as PII or bias information, etc.) can be deleted, obscured, or otherwise removed from data storage. However, sensor data can be otherwise managed.

Detecting an event based on the primitive values S400 functions to detect an actual or potential security event for a space or site. S400 is preferably performed by the event detection system, but can alternatively be performed by any other suitable system. S400 is preferably performed in real time (e.g., as the primitive values are received), but can alternatively be performed asynchronously from measurement or primitive value extraction (e.g., periodically, based on primitive values extracted from measurements within a predetermined time window, etc.). The event is preferably detected based on a set of primitive values, but can additionally or alternatively be detected based on a set of contextual information (e.g., values that are relevant to the sampling context, but not extracted from the measurements) and/or other information. Different events can be detected based on values for the same or different primitive set. Events for different spaces and/or sites are preferably be detected based on values for the same primitive set, but can alternatively be detected based on values for different primitive sets. In an example, the event detection system classifies a set of primitive values (e.g., from a single time window, from a single sampling epoch, from a series of sampling epochs, etc.) as one of a set of event classes. In a second example, the event detection system detects an event when the value of a primitive or frequency of the primitive value exceeds a baseline for the monitored space. In a third example, the event detection system detects an event using a set of heuristics and/or thresholds (e.g., wherein the event is detected when the primitive values satisfy a predetermined set of associated thresholds). In a fourth example, an event can be detected when a threshold number of different event detectors detect the same event based on the set of primitive values. In other examples, the event detection system detects an event using the methods disclosed in one or more of the detectors disclosed in: U.S. application Ser. No. 16/137,782 filed 21 Sep. 2018, U.S. application Ser. No. 16/816,907 filed 12 Mar. 2020, U.S. application Ser. No. 16/696,682 filed 26 Nov. 2019, and/or U.S. application Ser. No. 16/695,538 filed 26 Nov. 2019, each of which is incorporated herein in its entirety by this reference. However, an event can be otherwise detected.

The method can optionally include analyzing the event S500, which functions to determine whether the event is relevant to the physical site and/or monitored space (e.g., that the detected event is associated with), example shown in FIG. 4. This can be particularly useful when the event detection system is generic, since a security event for one site might not constitute a security event for another. In an illustrative example, a gun detected in a conference hall might constitute a security event, while the same gun detected in a gun shop may not. However, S500 can be used with site-specific event detection systems, with other event detection systems, and/or not used. S500 is preferably performed by an analysis module (e.g., specific to the site or type of site, specific to the monitored space or type of monitored space, etc.), but can alternatively be performed by any other suitable system. S500 is preferably performed based on the information (e.g., primitive value set, contextual information, etc.) used to detect the event, but can additionally or alternatively be performed using additional primitive values (e.g., from before and/or after the detected event), contextual values, and/or other information. The analysis module is preferably trained on site-specific primitive value data (e.g., a timeseries thereof, etc.) and/or site type-specific primitive value data, but can be otherwise trained. S500 is preferably performed in real time, after the event is detected in S400, but can alternatively be performed asynchronously or at any other suitable time. In a first example, S500 can include: determining whether the detected event is an anomaly for the site or monitored space (e.g., falls outside of a baseline or distribution specific to the space and the event type; using anomaly detection methods; etc.). In a second example, S500 can include: determining a probability for the detected event for the space, and treating the event as a true security event when the probability exceeds a threshold. However, S500 can be otherwise performed.

The method can optionally include notifying a user S600, which can function to surface the event to a site manager or security personnel. S600 can be performed: after S400 (e.g., responsive to S400), after S500 (e.g., responsive to S500), and/or at any other suitable time. The notification can be sent via: an interface, email, text, audio, and/or any other suitable communication method. The notification can include: an event identifier (e.g., a semantic descriptor of the event(s)), the primitive value(s) that triggered security event detection, the space or site identifier, and/or any other suitable information. Additionally or alternatively, the notification can include a non-semantic alert (e.g., an alarm) and/or any other suitable accompanying notification.

The method can optionally include explaining the detected event, wherein the identified primitives and/or contextual parameters (and/or values thereof) can be provided to a user, be used to identify errors in the data, be used to identify ways of improving the model, and/or otherwise used. The explanation can be determined using the explainability module and/or any other suitable module. The explanation can be determined: automatically, responsive to receipt of a user request for an explanation, in real- or near-real time (e.g., after S400), asynchronously from S400, and/or at any other suitable time.

The method can optionally include determining a security response S700, which functions to determine whether the user acted upon the notification and/or recommend a security response to the user. This can optionally determine the type of action the user took, the response time, and/or any other suitable response parameter. The response parameter can then be used to train, retrain, and/or update the event detection model, train the analysis module, and/or otherwise used. For example, responded-to events are treated as true events, wherein the event detection model and/or analysis module can be trained to detect an event given the underlying primitive value set. In a first variant, S700 includes determining the response that a user took responsive to the security event. Determining which security response was taken can be based on: input from a user (e.g., security personnel communications, a questionnaire, etc.), measurements (e.g., subsequent sensor measurements of the space observing the executed response, subsequent primitive values, etc.), and/or otherwise determined. In a second variant, S700 includes determining a security response recommendation based on the security event. The recommended security response can be based on historical responses to similar events, a ruleset (e.g., specific detected event triggers an automatic response), learned, and/or otherwise determined.

The method can optionally include retraining or otherwise updating one or more event detectors (e.g., event detector models) based on the determined security response of one or more monitored sites. Updating an event detector can function to improve the accuracy, reliability, and/or otherwise tune the event detection and/or response systems. An example of event detector retraining is shown in FIG. 7.

In variants, the primitive extractors can also be retrained. In a first variant, the primitive extractors are locally retrained or tuned (e.g., using unsupervised learning, using locally-labeled measurement data, etc.). In a second variant, the primitive extractors can be retrained at the centralized system (e.g., using a set of training measurements), then pushed to the local systems for execution. However, the primitive extractors can be otherwise retrained.

However, the method can be otherwise performed.

Different processes and/or elements discussed above can be performed and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously, concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A system comprising:
a local processing system installed within a site, the local processing system configured to:
determine a set of measurements generated by a plurality of sensors monitoring the site; and
determine a set of primitives based on the set of measurements; and
a remote processing system located remote from the site and configured to determine a set of events based on the set of primitives received from the local processing system.

2. The system of claim 1, wherein the set of primitives excludes personally identifiable information appearing within the set of measurements.

3. The system of claim 2, wherein the local processing system is further configured to delete the set of measurements after determining the set of primitives.

4. The system of claim 1, wherein the set of primitives are semantic primitives.

5. The system of claim 1, wherein the remote processing system is further configured to determine a response to an event of the set of events when the event is determined to be a security threat.

6. The system of claim 1, wherein the set of events are determined in near-real-time.

7. The system of claim 1, further comprising a plurality of local processing systems, each installed within a different site, wherein each local processing system is configured to determine a set of primitives based on a set of measurements of the respective site; wherein the remote processing system is configured to determine a set of events for each site based on the respective set of primitives.

8. The system of claim 1, wherein the local processing system is further configured to determine a set of primitives based on a first model set, and the remote processing system is further configured to determine a set of events based on a second model set.

9. The system of claim 8, wherein the remote processing system is further configured to re-train the second model set based on the set of events and a set of response parameters associated with the set of events.

10. The system of claim 1, wherein the set of primitives comprises a set of unique identifiers for each unique entity instance appearing within the set of measurements.

11. The system of claim 1, wherein the remote processing system is further configured to determine a security response based on the set of events.

12. A method comprising:
determining sensor data generated by a set of sensors monitoring a site;
determining a set of metadata based on the sensor data using a first model set, wherein the metadata comprises a set of primitives and excludes personally identifiable information within the sensor data; and
determining a set of events based on the metadata using a second model set.

13. The method of claim 12, wherein the set of metadata is determined by a local processing system located on the site, and the set of events is detected by a remote processing system located remote from the site.

14. The method of claim 12, further comprising determining whether a security threat is present at the site based on the set of events.

15. The method of claim 14, wherein determining whether a security threat is present at the site comprises determining whether a frequency of determined events for the site exceeds a baseline event occurrence frequency for the site.

16. The method of claim 14, wherein the security threat is determined based on a context associated with the sensor generating the sensor data and a ruleset associated with the context.

17. The method of claim 12, wherein each primitive is determined based on a set of features extracted from the sensor data.

18. The method of claim 12, wherein the set of primitives are semantic.

19. The method of claim 18, wherein the semantic primitives comprise at least one of entities or interactions.

20. The method of claim 18, wherein the semantic features exclude at least one of race, ethnicity, or gender.
